(19) United States
(12) Patent Application Publication
(10) Pub. No.: US 2004/0179485 A1
(43) Pub. Date: Sep. 16, 2004

(54) Method of transmitting and receiving two-way serial digital signals in a wireless network utilizing a simplified baseband processor

(76) Inventor: Carl M. Terrier, Clearwater, FL (US)

Correspondence Address: LARSON AND LARSON, 11199 69TH STREET NORTH, LARGO, FL, 33773

(21) Appl. No.: 10/387,065

(22) Filed: Mar. 12, 2003

(51) Int. Cl. H04B 7/00

(52) U.S. Cl. 370/310

(57) ABSTRACT

A method of transmitting and receiving a two-way serial digital signal in a wireless network is disclosed. The method utilizes a baseband processor to modulate user data along a 2.45 GHZ RF signal. The method permits the transmission and reception of data along the network between any two units without the need for assistance from other units to pass the data along the network. The method utilizes a protocol wherein a first network unit sends an acknowledgment packet to a second unit in response to receiving a data packet from the second network unit. The second unit will attempt to resend the data packet up to five times until it receives the acknowledgment packet from the first unit. Since the reception of data packets is considered more important than the transmission of data packets, each network unit will remain in a receive mode for a pre-defined period of time until it is determined that no data packets have been received at which time each network unit will inquire whether any packets are waiting to be re-transmitted or transmitted for a first time. If such packets are ready for transmission, the network unit will enter a transmit subroutine whereby a waiting packet will be transmitted.

### BACKGROUND OF THE INVENTION

1. Field of the Invention

This invention relates to a method of transmitting and receiving two-way serial digital signals in a wireless network. More particularly, it relates to a method of transmitting and receiving two-way serial digital signals in a wireless local area network (WLAN) wherein any two stations within the wireless network, of up to 256 stations, can communicate directly with one another, regardless of proximity of the two stations within the WLAN, without the need for dedicated hardware at each station to assist in the distribution of the signal from point to point.

2. Description of Prior Art

The networking of computer stations and other devices within a local area which may need to share information or resources is very well known in the prior art. Early advancements in device networking was accomplished through the use of cabling. Many different types of networks have been developed over the years in response for the need to share information or resources associated with a specific station (workstation) or control or sensing device.

Networks can be broadly defined as having a peer-to-peer or a client/server architecture. Peer-to peer networks combine a multitude of devices or workstations (nodes) which have equivalent capabilities and responsibilities. This differs from a client/server network wherein a specific device (server) manages resources and controls the flow of information on the network for the workstations (clients) which in turn are running individual applications at such stations. Peer-to-peer networks are considered more simple to operate but can lack in performance when heavy loads are placed upon the network. Client/server networks, albeit more complicated, are typically capable of handling these heavy loads. The type of network to be employed depends mostly on the application of the environment in which it is to be used (i.e., small business office, educational facility, hospital, manufacturing facility, utility substation, large industrial plant).

When used within a small confined environment, such as that seen in a small office building or an educational facility the network is referred to as a local area network (LAN) versus those that are employed over a wide area or WAN. One type of peer-to-peer LAN utilizes star topology (as shown in FIG. 1) which employs a hub or router, considered to be a center access point, which interconnects each station or device to all others within the network and provides the communication link therebetween. If any given station wishes to share information with another station, it must pass through this center access point. Another type of peer-to-peer LAN utilizes ring topology (not shown) wherein one station of the network is connected to a successive (or neighboring) station in a ring formation thereby permitting the transfer of information from any one station to any other given station on the network by passing it through the ring.

Peer-to-peer LANS, employing either a star or ring topology, can be used very effectively in small office environments, or any other local area configuration, wherein the resources and information of any given station may be easily shared with that of another. However, inherent problems exist in cabled peer-to-peer LANs. For instance, the speed of transfer of information is dependent upon the processing speed of the chosen cable and associated hardware of the network to which the cables connect. Further, as the network grows, more traffic is placed upon the network which in turn diminishes the speed of transfer throughout the entire network. Still further, conflicts and crashes can occur on the network due to an overloading by the network users or network control and sensing devices. Depending upon the environment in which the network is operating, data crashes can have huge consequences (i.e., an electrical power substation). Accordingly, it is imperative that data crashes be reduced or completely eliminated, if possible, within all types of LANs.

Another inherent problem with a cabled peer-to-peer LAN relates to the pathway in which data must travel to reach its destination from its source. For example, in the star topology protocol (as shown in FIG. 1), all data must travel through the hub or router (center access point) before it can reach its destination thereby providing an opportunity for the data to degrade or be loss. In a ring topology protocol, data must travel through the network and by a multitude of stations before it reaches its destination, thereby again, providing an opportunity for the data to degrade or be loss (i.e., crash). Still further, these types of cabled peer-to-peer LANs do not provide a manner by which the data can be sent redundantly, which has shown to increases data integrity and ensure final delivery of the data to its proper destination. For these reasons, a client/server architecture for the LAN may be more appropriate. However, even client/server LANS, in many instances, are unable to address the inherent deficiencies that exist when using cables to interconnect all of the workstations (nodes) to one another.

The advent of wireless technology for the transmission of data within a LAN has greatly improved the ability to address many of the inherent deficiencies in cabled LANs while providing many benefits not seen in a traditionally cabled LAN. This applies to both peer-to-peer and to client/server architecture.

The first and foremost benefit of a wireless network relates to the increased mobility as compared to a tethered or conventional cabled network. Users within a wireless network can move about almost without restriction thereby accessing LANs from nearly anywhere. Further, “ad-hoc” networks can be established quickly and efficiently when utilizing wireless transmission (i.e., a conference between a plurality of employees can easily establish a network to share information relative thereto with their laptop computers). Still further, significant cost reductions can be seen when utilizing wireless transmission between the nodes of a network due to the removal of the cable between all of the nodes and the server (if applicable). Reduced labor costs are also realized due to the fact that no cabling has to be “dropped.” Furthermore, wireless networks provide a greater amount of flexibility with respect to making a physical changes to the network or adding a network to an existing structure after construction is completed. The cabling for a network should ideally be dropped before construction of the building is completed. However, exiting buildings and those that can not be disturbed (i.e., those containing asbestos) do not have this luxury. The need to “fish” cables through walls after construction can be very expensive. Wireless networks therefore become quite attractive in these situations. Still even further, wireless networks can be used in conjunction with a cabled network due to its ease of installation and greater flexibility thereby providing subgroups within a larger cabled network. It should be noted however, that the type of wireless LAN used with any given environment is even more dictated by the need of that environment as compared to a cabled network. It is further understood that the “type of wireless network” refers to what type of architecture the network will have and which transmission rate, modulated frequency bands and encoding schemes will be used.

Wireless networks work on a principle that each node that may wish to communicate with another node or a server has some type of transceiver device for permitting the transmission and reception of wireless signals such that an over-the-air interface is established. The most common form of wireless signals used are RF signals or radio frequencies although other types of signals such as IR or infrared pulses can be used.

Many standards were developed in the early stages of wireless RF LAN development. To provide a level of consistency to the emerging technology, the Institute of Electrical and Electronics Engineers (IEEE) began accepting a standard in 1997 for wireless LAN technology known as 802.11. This standard has developed into a series or family of standards all falling under the umbrella of 802.11 (i.e., 802.11a, 802.11b, 802.1g) which address different transmission rates, different frequency bands as well as different encoding schemes (i.e., Direct Sequence Spread Spectrum or DSSS, Frequency Hopping Spread Spectrum or FSSS and even Orthogonal Frequency Division Multiplexing). Although the 802.11 standards have contributed greatly to the art of wireless networks, they tend to be very complicated and require a great deal of resources within the network to operate at proper efficiency. In many instances, due to the simplicity of the needs of a particular network, the 802.11 technology can be considered overwhelmingly complex and unnecessary. It can be said that 802.11 technology is simply “overkill” for many wireless scenarios. The need of many simple applications do not require the extensive processing speed that is common with 802.11 schemes. Further, 802.11 lacks the ability for the user to set many of the “user define” variables and must therefore accept the defined pre-sets provided by the 802.11 scheme. Still further, again due to its complex nature, conflicts can arise on a wireless network that has certain control devices and other resources which have not be tested with the 802.11 technology. This of course can lead to an increase in cost for troubleshooting for yet to be seen conflicts. Accordingly, there is a great need for new wireless network protocols which bases a framework around simplicity. The need for simplicity in a wireless network is even more desirable when addressing the needs of a very select or unique environment that does not require the “bells and whistles” of the 802.11 transmission protocol.

Besides complexity, other limitations exist with wireless RF networks known in the prior art. For one, it is very difficult to employ a wireless WAN due to the power needs to transmit an RF signal over such a wide area. Accordingly, wireless networks are most commonly used in LAN environments. However, it must be understood that even in the closed confined area of a LAN, inherent deficiencies exist within the exiting technology of the prior art of wireless networking.

One of the most inherent problems in wireless LANs relates to the interference of the transmitted signals. A barrier as simple as a wall can interfere with a transmitted signal thereby causing the signal to not reach its destination, commonly referred to as a “single point of failure.” It would of course be difficult to establish a small office which would not employ at least one wall, if not a plurality of walls, within the office that houses the wireless network. Accordingly, single point of failure is a problem which must be addressed in the use of wireless networks.

In an effort to stabilize wireless LANs and to reduce or completely eliminate these single point of failures, some advancements have been made in the prior art for wireless networks. For instance, as seen in U.S. Pat. No. 6,028,857, a self-organizing network is disclosed working on a principle of a decentralized “multi-hop” mesh architecture (as shown in FIG. 2). In particular, a multitude of nodes are provided within a LAN wherein each node is in direct communication with its immediate neighboring node or nodes. Accordingly, each node is configured to originate messages (as a source), be a destination of messages and also a relay of messages. The invention seen in U.S. Pat. No. 6,028,857 provides redundant communication pathways throughout a wireless network for automatically routing failed messages through an alternate route in response to single point failure and for permitting simultaneous transmissions to occur. This mesh architecture is similar to that which is seen on the Internet wherein a multitude of pathways are chosen to deliver a single message based upon the premise that at least one of the pathways will not fail and deliver the message as sent. It can be said though that this type of network scheme overburdens the wireless network unnecessarily. The main objective of this network is to establish a secure and stable wireless network which easily permits additional nodes to be added to the network and ensures delivery of the message through redundancy and rerouting. A network such at this would be very useful in roaming environments like that seen in many educational facilities where nodes (students) “wander” in and out of the network and reconfigure themselves each time they enter the network. As the student leaves, the network would merely consider this a failure of a node and reroute the message to the next closest available node. Although this prior art network has arguably simplified wireless network design over standard 802.11 schemes, it still has deficiencies that warrant improvement thereupon. Particularly, this type of wireless network and its associated scheme would not be useful in a utility substation since the equipment and other control devices seen therein do not wander in and out of the network (i.e., transformer is permanently situated in electrical substation). This “multi-hop” mesh network also requires repeaters to pass along messages to nodes that are positioned at more remote locations and requires each node within a pathway to act upon a message as a relay station thereby burdening it with additional responsibilities and taking time away from the more important responsibility of receiving messages that the particular node must act upon.

It would therefore be advantageous to provide a wireless LAN which reduces the need for additional hardware so that its configuration can be even more simplified. The mesh network described in U.S. Pat. No. 6,028,857 is also not very useful for streaming digital video applications since the channel bit rate is in the range of 200 Kbps. It would be advantageous to provide a wireless LAN having an increased channel bit rate which could handle the high bandwidth needs of streaming digital video but be more simplified than that which is known in the 802.11 technology.

An improved wireless network is clearly needed. Such an improved network should not be hampered by an over complex protocol and a need for additional hardware. An improved simplified wireless network should address the needs of a particular environment and satisfy those needs simply and effectively all the while providing an inexpensive answer to the simple needs of such environment. Expanded channel bit rates however should be employed to handle the needs of streaming digital video. By utilizing existing developed chip sets, further costs can be reduced all the while providing enhanced features such as the expanded channel bit rates. In the process of simplifying the wireless network, consideration should be placed upon how the data should be configured and subsequently transmitted. In furtherance of simplification, certain features however should not be abandoned, such as reliability/integrity of the transmitted data and redundancy of the transmission for ensuring eventual deliverance.

### SUMMARY OF THE INVENTION

I have invented a simplified wireless network which addresses the needs of particular environments and overcomes the deficiencies in the prior art. In particular, I have invented a method for transmitting and receiving two-way serial digital signals in a wireless network utilizing baseband processors. My protocol utilizes direct-sequence spread spectrum radio transmission. Data can be transferred at a rate of at least 1 Mbps thereby providing the ability to transmit streaming digital video. The novel wireless network permits any two nodes or stations of the network (configurable up to 256 stations) to communicate with one another without the need of assistance from stations along the transmitting pathway to relay such messages from the source to destination node. Any two nodes of the network can be coded in pairs thereby permitting the respective two nodes to communicate with one another all the while ignoring all other radio traffic on the wireless network. My novel wireless network performs extremely well in a SCADA (supervisory control and data acquisition) configuration such as one which is desirable in an electrical substation, wherein the wireless network employs a multitude of control and sensing devices that analyze real-time data and report any irregularities to a central site for display of the data in a logical and organized fashion for subsequent evaluation.

My novel wireless network further simplifies the transmitting process by eliminating a common first step of most wireless transmissions protocols wherein the sending or source node first listens to ascertain whether the transmitting channel is currently available. Although my wireless network only transmits a single message at a time, it does not address the network before transmitting its message after such message has been encoded; but instead, it merely transmits the burst. If the transmitting carrier is unavailable, then the protocol institutes a “back-off factor” scheme which places the message in line for eventual transmission. Accordingly, each node on the network can transmit its message at any time. Further, nodes which are known to only communicate with one another can be coded by their destination address bit in pairs to avoid other radio traffic on the network.

My novel network utilizes baseband processors operating in the 2.45 Ghz band. The chip set further includes a Media Access Controller (MAC), an I/Q Modulator/Demodulator and Synthesizer, an RF/IF Convertor and Synthesizer, a Power Amplifier and Detector, an Antenna Switch and an Antenna.

The MAC formats all data to be transmitted over the network into packets. The typical data field length of a packet is 60 bytes, wherein one byte each is utilized for a raw byte count, a protocol level, a source address, a destination address, a function code and a packet ID, two bytes are used for a cyclic redundancy check (CRC) and 52 bytes are employed for the actual data field.

### BRIEF DESCRIPTION OF THE DRAWINGS

The invention may be best understood by those having ordinary skill in the art by reference to the following detailed description when considered in conjunction with the accompanying drawings in which:

FIG. 1 is a depiction of a prior art star topology network scheme;

FIG. 2 is a depiction of a prior art mesh architecture network scheme;

FIG. 3 is a schematic diagram of the major components of a chip set utilized with the present invention;

FIG. 4 is a more detailed schematic diagram of a Media Access Controller of the chip set utilized with the present invention;

FIG. 5 is a more detailed schematic diagram of a Base Band Processor of the chip set utilized with the present invention;

FIG. 6 is a more detailed schematic diagram of an I/Q Modulator/Demodulator of the chip set utilized with the present invention;

FIG. 7 more detailed schematic diagram of an RF/IF Convertor and Power Amplifier of the chip set utilized with the present invention;

FIG. 8 is a flow diagram depicting an initialization routine within the method of transmitting a signal of the present invention;

FIG. 9 is a flow diagram depicting a configuration command routine within the method of transmitting a signal of the present invention;

FIG. 10 is a first of three parts of a flow diagram depicting a main loop routine of the method of transmitting a signal of the present invention wherein data packets are received and transmitted;

FIG. 11 is the second of three parts of the flow diagram depicting the main loop routine of the method of transmitting a signal of the present invention wherein data packets are received and transmitted;

FIG. 12 is the third and final part of the flow diagram depicting the main loop routine of the method of transmitting a signal of the present invention wherein data packets are received and transmitted;

FIG. 13 is a flow diagram of a receive packet subroutine implemented within the main loop routine of the method of transmitting a signal of the present invention; and

FIG. 14 is a flow diagram of a send packet subroutine implemented within the main loop routine of the method of transmitting a signal of the present invention.

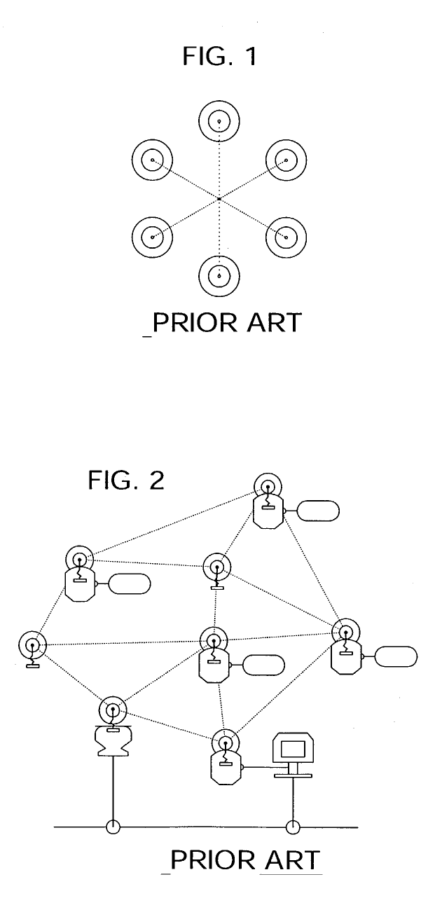

### DETAILED DESCRIPTION OF THE INVENTION

Throughout the following detailed description, the same reference numerals refer to the same elements in all figures.

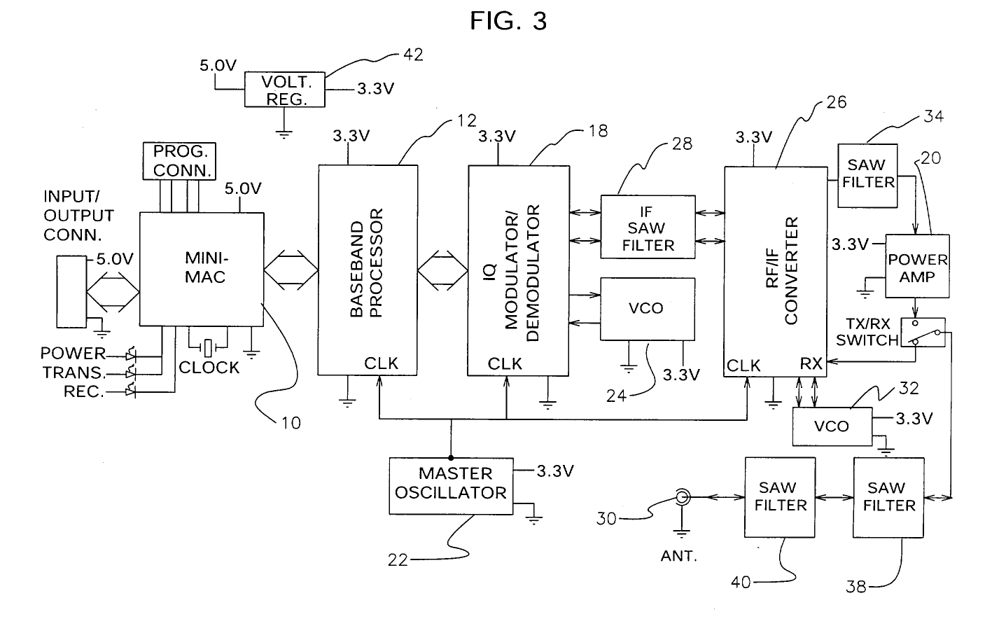

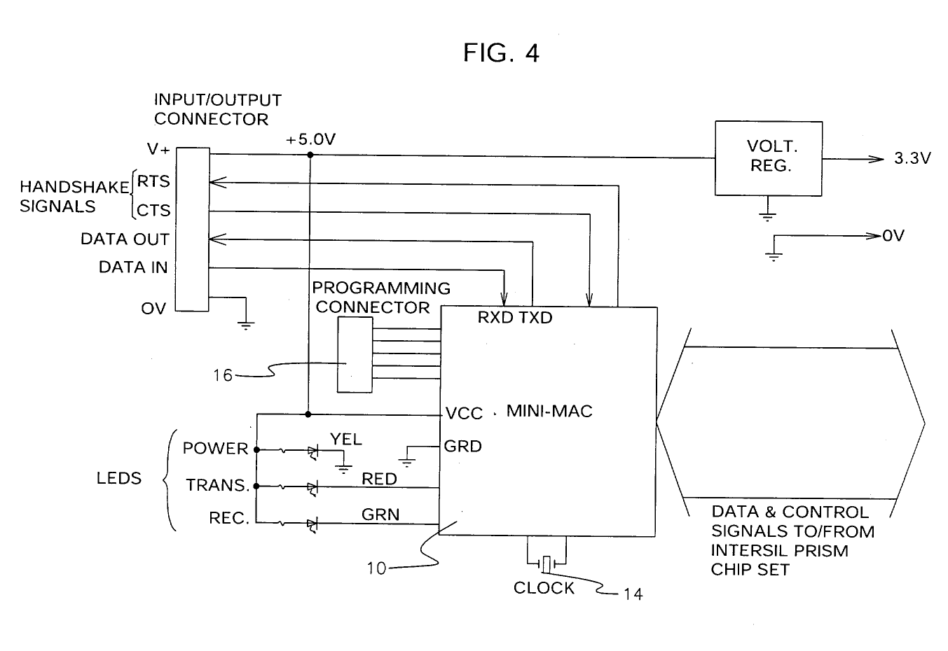

Referring to FIG. 3, a novel transceiver circuit is shown which is used to implement the transmission and reception of two-way serial digital signals in a wireless network. In particular, a Media Access Controller (MAC) 10 is employed which buffers Transmit and Receive data, formats data into packets and controls the remaining chip set of a baseband processor 12 employed within the circuit during all phases of Transmit and Receive routines. As shown in FIG. 4, MAC 10 has its own clock 14 and operates on 5.0 v DC supplied by an Input/Output Signal Connect 16. MAC 10 is control of all timing and sequencing of the entire transceiver circuit and controls all packet handling functions, including packet formatting, addressing, error-checking, transmit retries, data buffering and timing.

Referring to FIG. 3, it is shown that baseband processor (BBP) 12 is coupled to MAC 10. During transmit, BBP 12 accepts synchronous serial data from MAC 10 and modulates the data to baseband Inphase (I) and Quadrature (Q) voltage levels to feed a Transmit I/Q signal to an I/Q Modulator/Demodulator (IQ Modem) 18. During reception, BBP 12 accepts the I and Q voltage levels (Receive I/Q signal) from IQ Modem 12 which has demodulated an Intermediate Frequency (IF) signal received from an RF/IF Convertor 26 coupled to IQ Modem 18. The resulting data from the demodulated and de-scrambled signal is then feed out by synchronous serial interface to MAC 10. The transmission process begins with MAC 10 activating BBP 12 for transmission. BBP 12 generates a Preamble and a Header, then begins to clock the Transmit Data in from BBP 12. So long as BBP 12 remains in a transmit state, data bits are continuously clocked-in and transmitted. The reception process is initiated by MAC 10 activating BBP 12 for reception. BBP 12 monitors its I and Q Inputs for a Preamble and Header. Upon detection thereof, BBP 12 begins clocking Receive Data bits to MAC 10 and continues to do so until MAC 10 deactivates BBP 12 from its Receive State.

BBP 12 handles all Preamble and Header generation and checking, data scrambling and de-scrambling and chip modulation of data bits as directed by MAC 10 by way of BBP Control Registers which are accessed through a separate Serial Data Interface. For a transmit packet, MAC 10 must set the packet length (number of bytes in packet) into BBP 12 before the start of a transmit sequence. Once the length is set, BBP 12 then encodes the set packet length information into the Packet Header that it generates when sending the transmit packet. Conversely, when in receive mode, BBP 12 can determine the length of any incoming packet by decoding the Packet Header attached to said received packet generated by another BBP, within another transceiver node, on the network.

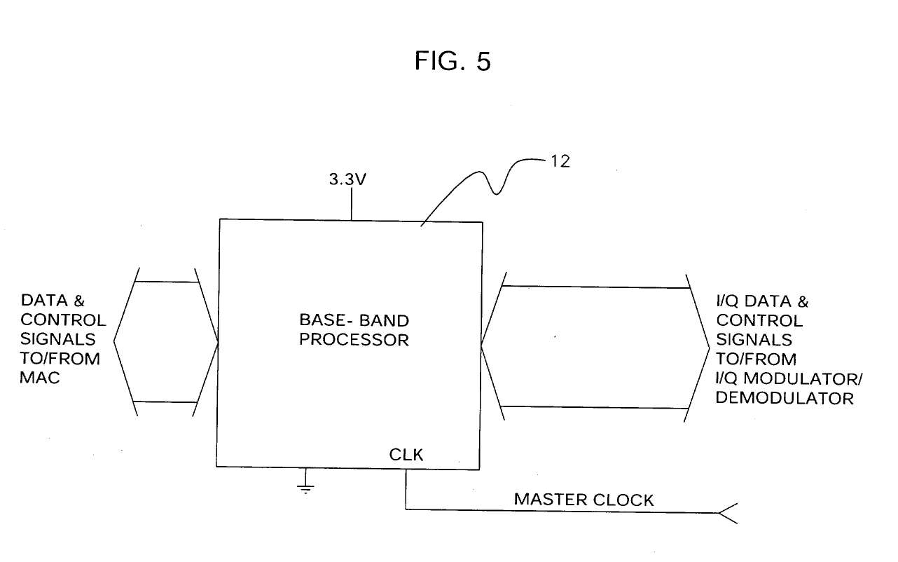

BBP 12 continuously operates at a data rate of 1 Mbps. During transmit, BBP 12 supplies a bit-clock for synchronizing data from MAC 10 to BBP 12 This bit-clock is generated for as many bytes as MAC 10 programs for any given packet. During receive, BBP 12 supplies the bit-clock and the data to MAC 10. This clock is generated for as many bytes as the incoming packet contains, as commanded by the Packet Header. As shown in FIGS. 3 and 5, BBP 12 is powered by 3.3 v DC obtained from Voltage Regulator 42. As shown in FIG. 3, BBP's clock is is provided by Master Oscillator 22 also operating under 3.3 v DC from Voltage Regulator 42.

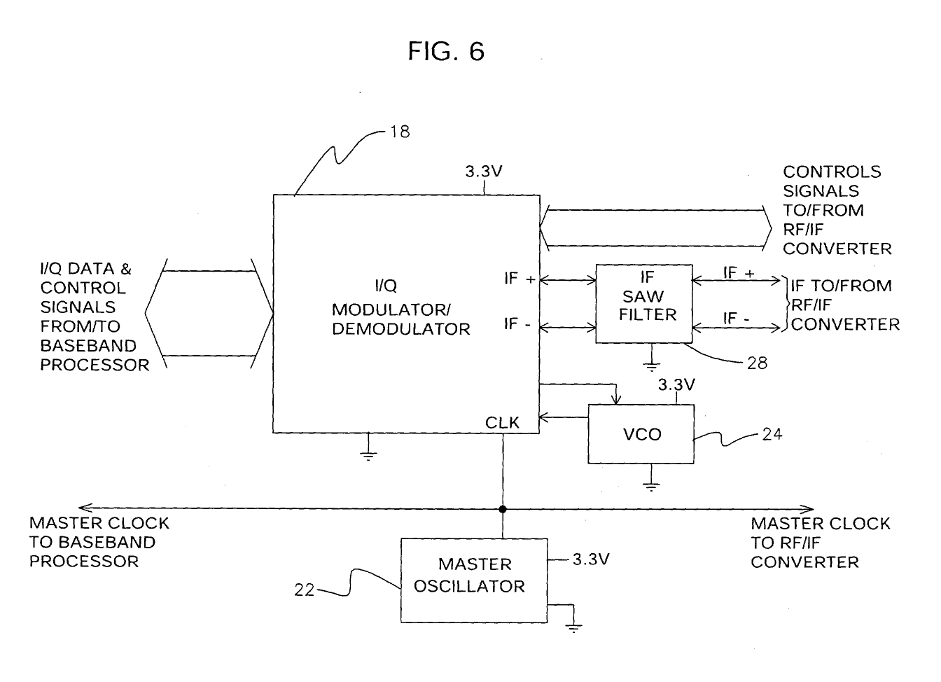

With reference to FIG. 3, IQ Modem 12 controls a first Voltage Controlled Oscillator (VCO) 24 which generates an Intermediate Frequency (IF) signal during transmit. In the preferred embodiment, a 374 MHz IF signal is employed. The IF signal is modulated with the Transmit I/Q signal from BBP 12 to generate a Transmit modulated IF signal. During receive, IQ Modem 12 demodulates a Receive modulated IF signal to produce a Receive I/Q signal to feed to BBP 12 MAC 10 controls a Phase-Locked-Loop (PLL) for the modulated IF signal by a serial data interface thereby maintaining a constant phase angle (i.e., lock) on the frequency of said IF signal. As shown in FIGS. 3 and 6, IQ Modem's clock is provided by Master Oscillator 22. IQ Modem 12 and first VCO 24 also operate under 3.3 v DC provided by Voltage Regulator 42.

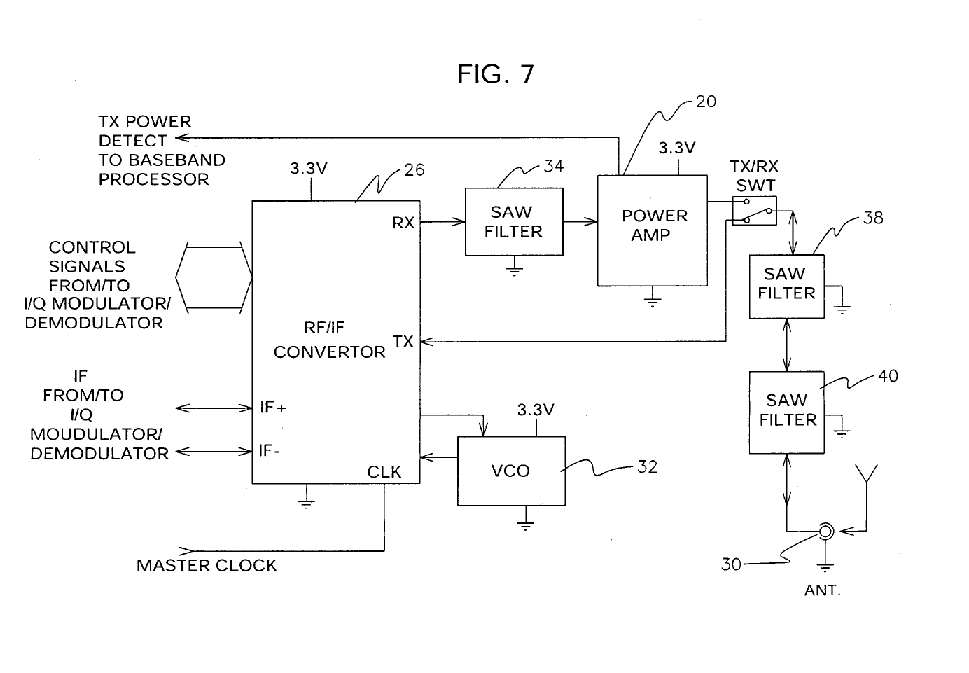

Both the Transmit and Receive I/Q signals are base-band signals having a data rate of 1 Mbps. During transmit, IQ Modem 12 uses the Transmit I/Q signal to modulate the 374 MHz IF signal thereby generating a 374 MHz waveform containing the 1 Mbps data. Conversely, during receive, IQ Modem 12 demodulates the 374 MHz waveform containing the 1Mbps data back to a base-band signal of 1 Mbps (Receive I/Q signal). During transmit, the modulated IF signal, generated by IQ Modem 18, is filtered by a Saw Filter 28 (see FIGS. 3 and 6) thereby removing any errant signals generated in response to the transmission process. Thereafter, the filtered modulated IF signal is passed onto RF/IF Convertor 26 for final conversion to an RF signal having a frequency of 2450 MHz (2.45 GHz) for transmission by an antenna 30 (see FIGS. 3 and 7). During receive, the modulated IF signal received from RF/IF Convertor 26 is filtered by Saw Filter 28 to again remove any errant signals that may have been generated during the reception process. Thereafter, the filtered modulated IF signal is demodulated to the 1 Mbps base-band signal which is then directed to BBP 12 for data extraction.

Referring to FIGS. 3 and 7, RF/IF Convertor 26 controls a second VCO 32 for generating a Local Oscillator (LO) signal for combining with the modulated IF signal thereby generating the RF transmit signal. In the preferred embodiment, the modulated IF signal is 374 MHz whereas the LO signal is 2076 MHz thereby generating a 2450 MHz (2.45 GHz) RF transmit signal (2076+374=2450). During transmit, RF/IF Convertor 26 receives the 374 MHz modulated IF signal from IQ Modem 12 and mixes it with the 2076 MHz second VCO 32 signal thereby generating a 2.45 GHz RF transmit signal. Prior to transmission, the 2.45 GHZ RF transmit signal is filtered by a second Saw Filter 34 and then passed along to Power Amp 20. During receive, RF/IF Convertor 26 receives the 2.45 GHz RF signal from antennae 30 (as shown in FIG. 7), thereafter mixing it with the 2076MHz second VCO 32 signal to generate a 374 MHz modulated IF signal (2450−2076=374). The 374 MHz modulated IF signal is then filtered by first Saw filter 28 and then passed along to IQ Modem 12 as shown in FIG. 3. As with IQ Modem 18, MAC 10 controls the PLL for the LO signal by a serial data interface thereby maintaining a constant phase angle (i.e., lock) on the frequency of the IF signal. As shown in FIG. 3, RF/IF Convertor's clock is provided by Master Oscillator 22. RF/IF Convertor 26 and second VCO 32 also operate under 3.3 v DC provided by Voltage Regulator 42.

Referring to FIGS. 3 and 7, Power Amp 20 boosts the RF Transmit signal to a final 30 mW level for transmission by antennae 30. Power Amp 20 also contains a detector which samples an output of Power Amp 20 thereby providing a voltage level indication on transmit power which is used by MAC 10 to control the output power of the circuit as necessary for maximum transmit range. MAC 10 enables Power Amp 20 during a transmit state and disables it during a receive or idle state. This is accomplished by MAC 10 controlling an Antenna Switch 36, by two digital lines, wherein Power Amp 20 is connected to Antennae 30 during transmit and RF/IF Convertor 26 is connected to Antennae 30 during receive and idle. As shown in FIGS. 3 and 7, third and fourth Saw Filters 38 and 40, respectively, are coupled between Antennae 30 and Antennae Switch 36 providing additional filtering for any errant signals attached to the 2.45 GHz Transmit or Receive Signal.

As stated before, BBP 12 will operate at a peak data rate of 1 Mbps (125 KBytes/sec), a data rate sufficient for the transmission of streaming digital video. BBP 12 generates its own synchronizing Preamble and Header, which is 96 μS in length. The preferred length (Raw Byte Count) of the packet is 72 Bytes having an average packet transmission time of approximately 600 μS. The packet includes:

| BYTE INDEX | CONTENTS | VALUE | SIZE |
|---|---|---|---|
| 0 | Raw Byte Count | n+8 | 1 |
| 1 | Protocol Level | $01 | 1 |
| 2 | Source Address | 1-250 | 1 |
| 3 | Dest Address | 1-255 | 1 |
| 4 | Function Code | $xx | 1 |
| 5 | Packet ID | 0-255 | 1 |
| 6...n+5 | Data Field | User Data | n |
| n+6, n+7 | CRC | $xxx | 2 |

The Raw Byte Count holds the zero (0) Byte Index position, is one byte in size and has a value of n+8, wherein n equals the byte size of the User Data contained in the Data Field. In the preferred embodiment, n equals sixty-four (64). Accordingly, the Raw Byte Count in the preferred embodiment has a value of sixty (72). The Protocol Level holds the number one (1) Byte Index position, is one byte in size and has a value of $01 representing a first version thereby permitting updates to be made to the transmission protocol or associated hardware that transmits and receives the packets. The Source Address holds the number two (2) Byte Index position, is one byte in size and has a numeric value somewhere between one (1) and two-hundred and fifty (250) such that each transceiver employed in the network can be uniquely identified as the source of a transmission by its Source Address numeric identifier. The Dest (Destination) Address holds the number three (3) Byte Index position, is one byte in size and has a numeric value somewhere between one (1) and two-hundred and fifty-five (255) such that each transceiver employed in the network can be uniquely identified as the intended recipient of a transmission by its Dest Address numeric identifier. The numbers 1-250 are reserved for actual transceivers, whereas the numbers 251-254 are reserved for Multicast and the number 255 is reserved for Broadcast. Multicast permits the sub-grouping of transmission recipients whereas Broadcast permits transmission to all units on the network. The Function Code holds the number four (4) Byte Index position, is one byte in size and has a value which designates the purpose of the data transmission. In the preferred embodiment, the following designations are utilized:

$02 Request for Acknowledgment

$03 Non-Data Acknowledgment

$04 Data to Destination Address

$05 Acknowledgment of Data Packet

Further function complexity can be added by extending the table of Function Codes. The Packet ID holds the number five (5) Byte Index position, is one byte in size and has a numeric value somewhere between zero (0) and two-hundred and fifty-five (255). The Packet ID is a sequential number used to differentiate packets thereby permitting acknowledgment of individual packets by the Destination (recipient) unit to the Source unit. When a valid packet is received by the intended Destination unit, an acknowledgment is sent back to the Source unit of the transmitted packet by transmitting an Acknowledgment of Data Packet (containing no Data Field) with the same numeric Packet ID value as the transmitted message. The Data Field holds the number six (6) to number n+five (n+5) Byte Index positions wherein n is the byte size of the contents within the Data Field; the value of the Data Field is the User Data to be transmitted. To illustrate the byte size and Byte Index for the User Data, if the User Data is sixty-four (64) bytes in length, then the Byte Index holds the positions six (6) through sixty-nine (69). The last two bytes of the Data Packet contain a 16-bit Cyclic Redundancy Check (CRC), which is used to determine any data transmission error. The CRC holds the n+six (n+6) and the n+seven (n+7) Byte Index positions wherein n is the byte size of the User Data in the Data Field. Accordingly, in the preferred embodiment, wherein the length of the User Data is sixty-four (64) bytes, the CRC would hold the seventieth (70) and seventieth-first (71) Byte Index positions.

The protocol used in the present invention is a multiple-access protocol. Accordingly, each unit (node) of the wireless network can transmit at any time. There is no need for a given unit on the network to verify whether there is an open channel to transmit a packet as seen in the prior art. Therefore, the possibility exists that two or more units are transmitting simultaneously, but with only one available channel to transmit thereupon; this occurrence could result in a collision. The possibility of collisions increases when the number of units increases on the wireless network

In the event of a collision, or other error in reception, the Acknowledgment of Data Packet packet from the Destination unit is not received by the Source unit. If this occurs, MAC 10 of the Source unit waits for a random period of time within a predetermined range of 1-5 mS, then waits for an additional 1mS for an idle channel and thereafter re-transmits the Data Packet. In the preferred embodiment a maximum of five attempts will be made to re-transmit the Data Packet, after which time the packet will be discarded.

When a packet is received properly, MAC 10 of the Destination unit immediately responds with an Acknowledgment of Data Packet packet thereby taking advantage of the 1 mS idle channel requirement with the assumption that no other units within the wireless network would begin a transmission at that point in time. In the event that the Source unit does not receive an Acknowledgment of Packet packet, it assumes that the Data Packet did not reach the intended Destination unit. The Source unit will then re-transmit the Data Packet, a maximum of five time as stated above, until it receives its Acknowledgment. MAC 10 of the Destination unit will discard any re-try Data Packets after it has correctly received the Data Packet from the Source unit by analyzing each incoming packet and determining that the given packet has the same Packet ID as a previously received packet. Even though the redundantly received packets are discarded by the Destination unit, Mac 10 of the Destination unit will still send an Acknowledgment of Packet packet for all received transmissions (including all discarded retries) so that the Source unit knows that the Destination unit actually received the Data Packet transmitted thereby.

As previously stated, units (nodes) within the wireless network of the present invention may be coded in pairs wherein a first unit always specifies a Destination Address assigned to a second unit, and the second unit always specifies a Destination Address assigned to the first unit. In this scenario, the coded pair only communicate with one another, effectively ignoring all other radio traffic along the wireless network. This scheme can be used to replace a wired mode wherein the operator desires a specific pair of units to only communicate with each other, thereby simulating an RS-232, RS-422, or RS-485 cable.

Units of the wireless network may also be coded with a Master unit and multiple Slave units. In this scheme, the Master Unit needs to be informed of the intended Destination Address for each packet sent. This is realized by attaching a Header to each packet sent so as to inform the Mater Unit of the Destination Address for said packet. The Slave unit returns any response to the Master unit which an attached Header to indicate from which Slave unit the packet was received.

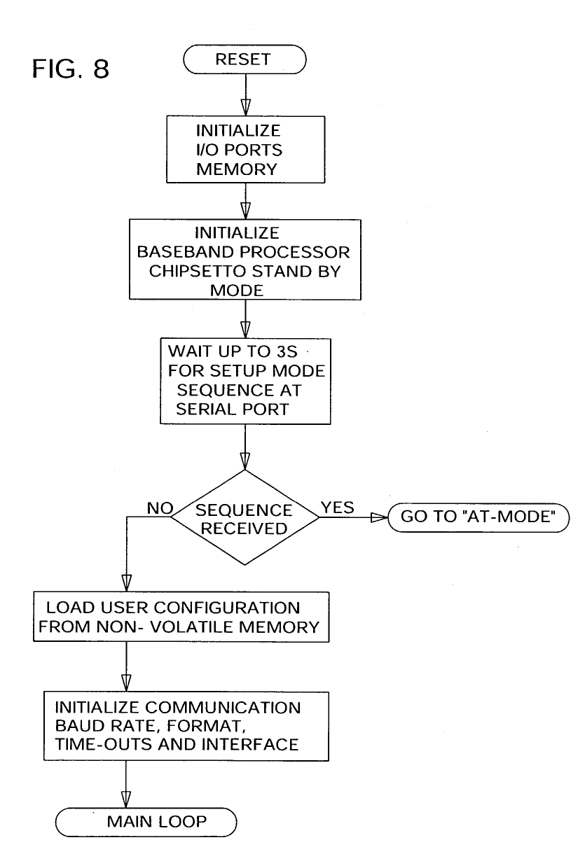

Referring now to FIG. 8, a flow chart is shown depicting the steps of a Reset routine (Power-Up) used in the method of transmitting and receiving two-way serial digital signals in a wireless network utilizing a baseband processor of the present invention. The Reset routine is used to load user configuration data from either non-volatile memory or from a serial port connection prior to placing the transmission method in a Main Loop routine for transmission or reception of Data Packets. The Reset routine would be used when the wireless network is first installed within a facility, when updates to the user configuration are desired or when the network is re-booted.

In the Reset routine, I/O ports of memory employed in a circuit are first initialized. Thereafter, baseband processor (BBP) 12 is initialized to enter a stand-by mode. Next, a time interval of up to three (3) seconds passes for determining whether a set-up sequence is going to be applied to a serial port. A query is then asked whether a set-up sequence has been applied. If the answer is “yes”, then the Reset routine enters an AT-Mode subroutine used as a first-time upload for the user configuration, to update user configuration data or to load a different configuration than that which is stored within the non-volatile memory. If the answer is “no” to the query of whether a set-up sequence has been applied to the serial port, then the user configuration is loaded from non-volatile memory. The loading of the user configuration initializes the communication baud rate, the format of the transmission, any time-outs to be employed and any interfaces to be used. Thereafter, the method of transmission of the present invention enters a Main Loop routine.

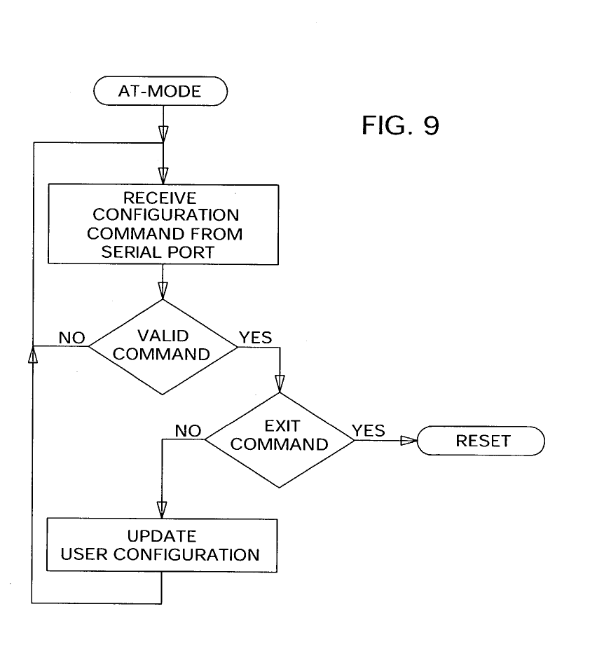

Referring to FIG. 9, if the method entered the AT-Mode subroutine, then the circuit waits to receive a configuration command at a serial port. A query is asked whether the configuration command is a valid command. If the answer is “no”, then the circuit looks to see if any configuration commands have been applied to the serial port since the last time it looked and continues to loop until the answer to whether a valid command has been received is “yes”. Upon receiving an answer of “yes” to the query of whether the configuration command is valid, then a second query is made whether an exit command has been received. If the answer to this query is “yes”, then the circuit re-enters the Reset routine (as shown in FIG. 8) and carries out the steps as described hereinabove until the method enters the Main Loop routine. If the answer is “no” to the query of whether an exit command has been received, then the routine loops back to the beginning of the AT-Mode subroutine until such time that the subroutine receives the correct commands that permit it to re-enter the beginning of the Reset routine which eventually leads the method of transmission of the present invention to the Main Loop routine.

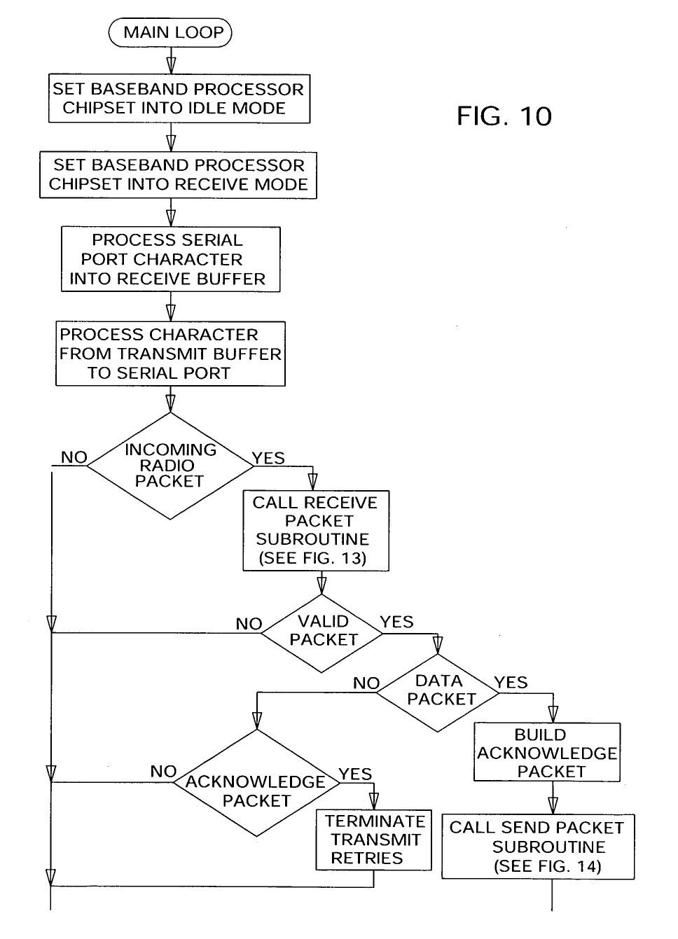

Referring to FIGS. 10-12, the Main Loop routine of the method of transmitting and receiving two-way serial digital signals in a wireless network of the present invention is depicted. First, as shown in FIG. 10, the baseband processor 12 is set to an Idle Mode (in the preferred embodiment, a PRISIM® processor is employed for baseband processor 12). Thereafter, baseband processor 12 is set to a Receive Mode. Next, if a serial port character is available it is processed into a receive buffer. Then, if a character from a transmit buffer is available it is processed into the serial port. This short subroutine is done as an efficiency factor to utilize all available time, albeit a very small amount of time, wherein no incoming packets have been received. This subroutine is especially important in higher baud rates beginning with those at and above 9600 baud. Failure to do so at these higher transmission rates could lead to missing incoming bytes or missing bytes to be transmitted.

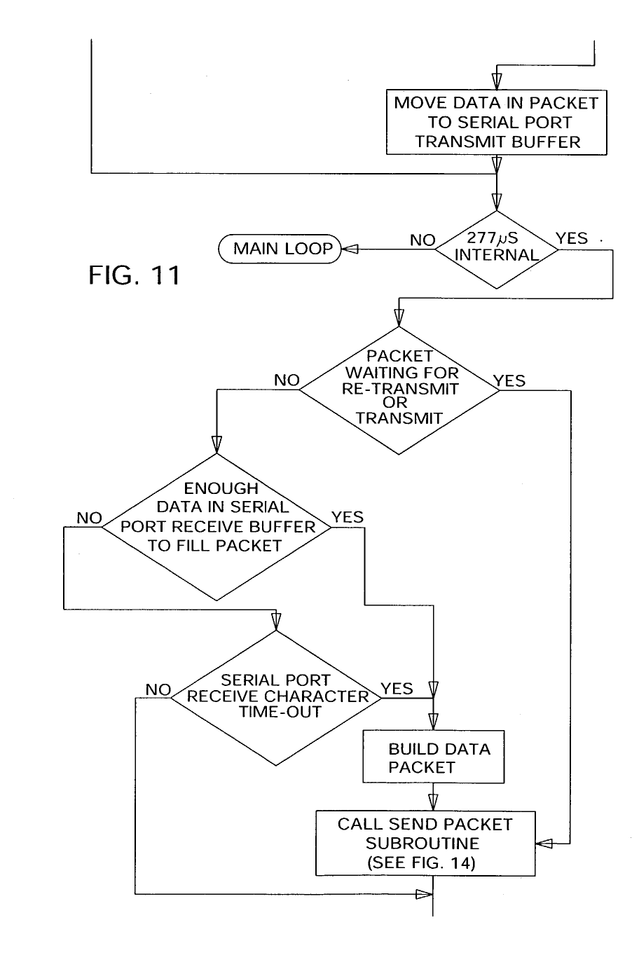

At this point, the circuit is ready to inquire whether there are any incoming radio packets. If the answer is “no”, then it is next asked whether a time increment of approximately one-quarter mS (277 uS in the preferred embodiment) has elapsed (see FIG. 11). If the answer to this query is “no”, then the the circuit loops back to the beginning of the Main Loop routine (top of FIG. 10) to again process any serial port characters into the receive buffer and to process any characters from the transmit buffer to the serial port, and to again inquire whether an incoming radio packets have been received.

In the event that no incoming radio packets have been received within the 277 uS time frame, this looping process, as just described, occurs approximately thirty to forty times before the 277 uS time increment elapses, thereby efficiently utilizing all available time when no incoming radio packets are being received to perform other tasks that are set at a lower priority than that of receiving incoming packets (the highest priority).

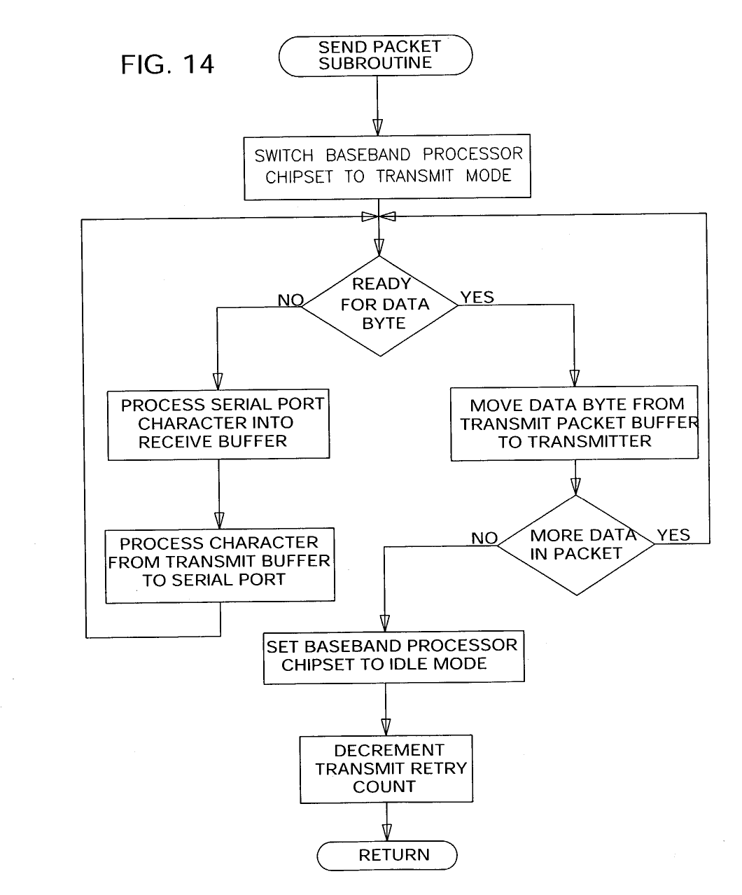

With continuing reference to FIG. 11, when the 277 uS time increment elapses, a query is asked whether there are any packets waiting for re-transmission or transmission (re-transmission of packets takes priority over building and transmitting new packets so as to not overburden resources and to finish all previous transmitting tasks before undertaking new ones). If the answer is “yes” to this question (no acknowledgment packet received), then a call is made to run a Send Packet subroutine (as shown in FIG. 14, to be discussed in full detail hereinbelow) which results in the transmission of a packet. The Send Packet (transmit) subroutine of the Main Loop occurs at this point within the method of transmitting and receiving two-way serial digital signals since receiving a packet, as stated before, is set as a higher priority task than transmitting a packet (i.e., send packets less often than checking for the reception of packets). As will be explained below hereinafter, so long as a unit is constantly receiving incoming packets, the transmission of any outgoing packets, be it new packets or re-tries, will be held in abeyance until such time as there are no packets to be received. Accordingly, the opposite is also true. So long as no incoming packets have been received and a pre-defined time increment has elapsed to confirm such state, all packets waiting for re-transmission or transmission will be sent.

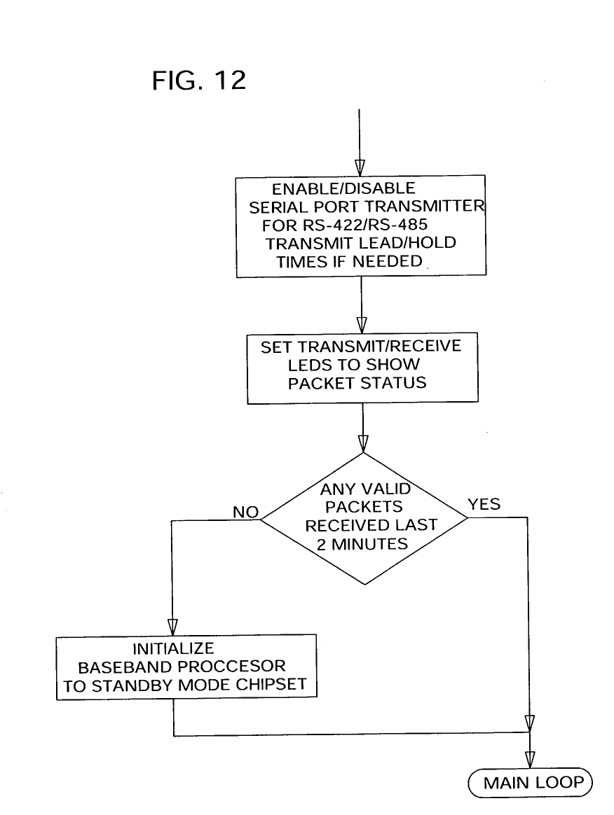

With further reference to FIG. 11, if the answer is “no” to the query of whether there are any packets waiting for re-transmission or transmission, it is next asked whether there is enough data in the serial port receive buffer to fill a packet. If the answer to this query is “yes”, then a data packet is built and a call is made to run the Send Packet subroutine of FIG. 14. However if the answer is “no”, then another query is asked whether a serial port receive character time-out has occurred. This time-out is inserted to permit the method to make an intelligent decision of whether to proceed further (and when) without waiting for more bytes to appear at the serial port receive buffer. For example, if no time-out was inserted, if the intended received packet is to be 72 bytes but only 60 bytes have been received, the method will hang-up waiting for the other 12 bytes. However, by permitting a time-out to elapse tells the method that all bytes that are going to be received have ben received. Therefore, if the answer is “yes” to the query of whether the serial port receive character time-out has occurred, then a data packet is built and a call is made to run the Send Packet subroutine on the presumption that all data that is to be received has actually been received. However if the answer is “no” to the query of whether a serial port receive character time-out has occurred, no packet is built, but instead a short subroutine (as seen in FIG. 12) runs before looping back to the beginning of the Main Loop thereby permitting the method to look for more incoming data. This time-out is a user defined parameter but should be as short as possible. In the preferred embodiment, it is three times the length of a character byte.

As shown in FIG. 12, a serial port of a transmitter for an RS-422 or RS-485 interface is either enabled or disabled, since these two interfaces can not receive data while the transmitter is enabled. Accordingly, their transmitters must be enabled to transmit and disabled in order to receive (as distinguished from the RS-232 interface wherein transmit and receive is always on). Thereafter, lead and hold times are transmitted (if needed), for ensuring a clean transmission line prior to, and subsequent to transmission. In the preferred embodiment, the lead and hold times should be as short as possible so as not to slow down the circuit (i.e., ≧0 mS). Next, transmit and receive LEDs are set to show packet status (Red for transmit and Green for receive—see FIG. 4). It is then queried whether any packets have been received in the last two minutes. If the answer is “yes”, then the method returns to the beginning of the Main Loop as shown in FIG. 10 to act upon these packets. If the answer is “no”, then the baseband processor chipset is initialized to a Standby Mode whereafter the method is returned to the beginning of the Main Loop. The two minute time period can be user defined and acts as a “deadman switch” to ensure that the processor has not been upset, rendering it unable to receive (i.e, no packets received in certain time period may indicate error). Depending on the operation of the network, the two minute period of not receiving any new packets may not occur for months or even years.

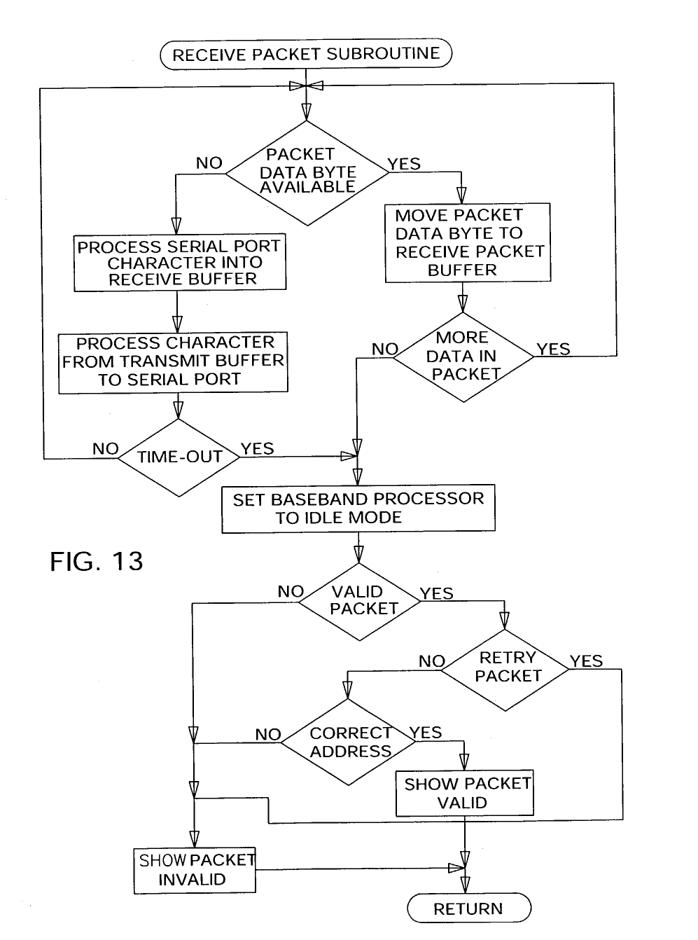

Referring back now to FIG. 10, if the answer is “yes” to the query of whether there is any incoming packet to receive, a call is made to run a Receive Packet subroutine (as shown in FIG. 13, to be discussed in full detail hereinbelow). Presuming that the Receive Packet subroutine of FIG. 13 has run in its entirety, it is next asked whether the packet is valid. If the answer to this question is “no”, then the method moves to a point in the Main Loop routine of the 277 uS time interval as shown on FIG. 11 and continues therethrough as previously described hereinabove. However, with reference back now to FIG. 10, at the point wherein a packet has been received and the Receive Packet subroutine has run in its entirety, if the answer is “yes” to the query of whether the packet is valid, it is next asked whether the packet is a data packet. If the answer to this question is “no”, it is then asked whether the packet is an acknowledgment packet. If the answer to this question is also “no”, then the method moves to the point in the Main Loop of the 277 uS interval as shown in FIG. 11 and continues therethrough as previously described hereinabove. This occurs since if the incoming packet is neither an acknowledgment packet nor a valid data packet, then whatever has been received is not something intended for this unit and is accordingly ignored. If the answer is “no” to whether it is a data packet, but “yes” to being an acknowledgment packet, then all transmits retries are terminated and the method moves to the point in the Main Loop of the 277 uS interval as shown in FIG. 11 and continues therethrough as previously described hereinabove. This occurs since once the unit knows that a previously transmitted packet has been received by its intended destination, there is no further need to attempt to any further re-transmissions of the packet.

Referring now to FIG. 13, the Receive Packet subroutine is shown which is called upon immediately after verifying that an incoming radio packet has been received. The Receive Packet subroutine does not discriminate against data packets versus acknowledgment packets, but instead follows a series of steps to verify that what has actually been received is data intended for the unit, regardless of whether it may have received this data before. Accordingly, it is first asked whether a packet data byte is available. If the answer is “no”, then two steps which have been previously undertaken earlier in the Main Loop routine are called upon again; namely, processing any serial port character into the receive buffer and then processing any character transmit buffer to the serial port. As stated before, this is done as an efficiency factor to utilize any available time which may elapse in between receiving and processing incoming radio packets. These two steps will continue for a pre-defined period of time so long as no packet data byte is available. If the pre-defined time period elapses and no packet data byte became available, then the baseband processor chipset is set back to idle mode, since it had been previously set to receive mode earlier in the Main Loop (see top of FIG. 10) and since no reception will occur this time around through the running of the code. In accordance therewith, as shown in FIG. 13, a query is asked whether a valid packet has been received. With an answer of “no”, the packet is shown to be invalid and returns to the portion of the Main Loop of FIG. 10 wherein it is asked whether the packet is valid. Since the answer again is “no”, as previously described and as shown in FIGS. 10 and 11, the method moves to the point in the Main Loop of the 277 uS interval query and continues therethrough either looping back around to the top of the Main Loop, in the case where the 277 uS time interval has not expired thereby looking for more potential incoming packets, or to seeing whether there are any packets to re-transmit or transmit, in the case where the 277 uS time interval has expired.

Referring back now to FIG. 13, if the answer is “yes” to the query of whether a packet data byte is available, such packet data byte is moved into the receive packet buffer. It is then asked whether there is more data in the packet. If the answer is “no”, then the baseband processor chipset is set to idle mode since there is a presumption that all that was intended to be received has in fact actually been received. However, if the answer is “yes” to the query of whether there is more data in the packet, the code will continue to loop around to the beginning of the Receive Packet subroutine until such time as there is no more data in the packet to buffer. When such point is reached, the baseband processor chipset is set to idle mode. Thereafter, it is asked if the packet is valid. If the answer is “yes”, then it is next asked if the packet is a retry packet (one that may have already been previously received). If the answer to this question is yes then it is shown that the packet is invalid and the code returns to the point in the Main Loop of FIG. 10 wherein it is asked whether the packet is valid. Since the answer will obviously be “no”, as previously described and as shown in FIGS. 10 and 11, the code moves to the point in the Main Loop of the 277 uS interval query and continues therethrough either looping back around to the top of the Main Loop, in the case where the 277 uS time interval has not expired thereby looking for more potential incoming packets, or to seeing whether there are any packets to re-transmit or transmit, in the case where the 277 uS time interval has expired. However, if the answer is “no” to the question of whether the packet is a retry packet, it is next asked whether the packet has the correct destination address. If the answer is “no”, then it is an invalid packet, as to this receiving unit, whereby the code returns to the Main Loop of FIG. 10 wherein it is asked whether the packet is valid. Since the answer will again obviously be “no”, as shown in FIGS. 10 and 11, the code moves to the point in the Main Loop of the 277 uS interval query and continues therethrough either looping back around to the top of the Main Loop, in the case where the 277 uS time interval has not expired thereby looking for more potential incoming packets, or to seeing whether there are any packets to re-transmit or transmit, in the case where the 277 uS time interval has expired. However, with reference back to FIG. 13, if the destination address is correct (answer “yes”), the packet is shown to be valid wherein the code returns to the Main Loop of FIG. 10, wherein it is asked whether the packet is valid. Since this time the answer to this question will be “yes”, the unit acts upon the received packet as previously described hereinabove and shown in FIG. 10.

Referring now to FIG. 14, the Send packet subroutine is shown. The baseband processor is first set to the transmit mode. It is then asked whether a data byte is ready. If the answer is “no”, then the short efficiency factor subroutine is run, as described before, wherein any serial port characters are processed into the receive buffer followed by processing any characters from the transmit buffer until such time as a data byte is ready. In that regard, if the answer is “yes” to whether any data bytes are ready, such data byte is moved from the transmit packet buffer to the transmitter. It is then asked whether there are any more data bytes in the packet. If the answer is “no”, then the packet is transmitted, the baseband processor chipset is set back to idle mode, the transmit retry counter is decremented (if this was a re-transmit) and set if it is an original first sent packet, and the routine returns to a point in the Main Loop at the top of FIG. 12. However, if the answer is “yes” to the question of whether there is any more data in the packet, the routine loops back and looks for such additional data, moves such additional data from the transmit packet buffer to the transmitter and eventually transmits the packet when no more data is available. And then of course, the subroutine then returns to the point in the Main Loop at the top of FIG. 12.

Equivalent steps can be substituted for the ones set forth above such that they perform the same method in the same way for achieving the same result.

Having thus described the invention what is claimed and desired to be secured by Letters Patent is:

1. A method of transmitting and receiving a two-way serial digital signal in a wireless network between a first and second unit of the network, the first and second network unit each having a unique pre-defined source and a destination address, the two-way serial digital signal being an original data packet, a retried data packet or an acknowledgment packet, each packet having a source and a destination address associated with the source and destination address of the first and second network units, the steps of the method comprising:
a) providing an electrically coupled chipset including a serial port, a media access controller, a baseband processor, an I/Q modem, an RF/IF convertor, an antennae and a DC power source for each first and second network unit,
b) setting the chipset for the first network unit into a receive mode,
c) determining whether an incoming digital signal is being received by the first network unit,
d) initiating a receive packet subroutine within the first network unit,
e) determining by the first network unit whether the incoming digital signal is a valid packet intended for the first network unit,
f) determining by the first network unit whether the valid packet is a data packet,
g) building an acknowledgment packet within the first network unit for immediate transmission to the second network unit,
h) initiating a send packet subroutine within the first network unit for transmitting a digital signal chosen from the group consisting of an acknowledgment packet, a retried data packet or an original data packet, and
i) setting the chipset for the first network unit into an idle mode.

2. The method of claim 1, wherein subsequent to the step of setting the chipset into a receive mode but prior to the step of determining whether an incoming digital signal is being received, further comprising the steps of:
a) processing any serial port characters into a receive buffer of the first network unit, and
b) processing any characters from a transmit buffer to the serial port of the first network unit.

3. The method of claim 1, further comprising the step of terminating the transmission of a retried data packet in the event that the incoming digital signal is an acknowledgment packet having a destination address equivalent to the destination address of the first network unit.

4. The method of claim 1, wherein subsequent to setting the chipset for the first network unit into an idle mode, further comprising the step of determining whether a pre-defined time-out has elapsed.

5. The method of claim 4, wherein subsequent to determining that the pre-defined time-out has elapsed, further comprising the step of determining whether any retried or original data packets are waiting to be transmitted.

6. The method of claim 5, wherein subsequent to determining that a retried or an original data packet is waiting to be transmitted, further comprising the step of initiating the send packet subroutine.

7. The method of claim 5, wherein subsequent to determining that no retried or original data packets are waiting to be transmitted, further comprising the steps of:
a) determining whether there is enough data in a serial port receive buffer to fill a data packet,
b) building a data packet, and
c) initiating the send packet subroutine.

8. The method of claim 1, wherein during the step of initiating the send packet subroutine, further comprising the steps of:
a) accepting by the baseband processor synchronous serial data from the media access controller,
b) modulating said serial data to baseband inphase and quadrature voltage levels for feeding a transmit inphase/quadrature signal to the IQ modem,
c) generating an intermediate frequency by a voltage controlled oscillator controlled by the IQ modem,
d) modulating the intermediate frequency with the transmit inphase/quadrature signal for forming a transmit modulated IF signal,
e) feeding the transmit modulated IF signal to the RF/IF convertor,
f) converting the transmit modulated IF signal to a transmit modulated RF signal by the RF/IF convertor, and
g) transmitting the transmit modulated RF signal by the antennae.

9. The method of claim 8, wherein the transmit modulated IF signal is 374 MHz.

10. The method of claim 8, wherein the transmit modulated RF signal is 2.45 GHz.

11. The method of claim 1, wherein the receive packet subroutine comprises the steps of:
a) determining whether a packet data byte is available,
b) moving the available packet data byte to a receive packet buffer,
c) determining whether any more data is available in the packet,
d) setting the chipset for the first network unit into an idle mode,
e) determining whether the packet is valid,
f) determining whether the packet is a retried packet,
g) determining whether the packet has a destination address equivalent to the destination address of the first network unit, and
h) designating the packet as a valid packet.

12. The method of claim 11, wherein the packet is designated as an invalid packet in the event that the packet is determined not to be valid, that the packet is a retried data packet or the destination address of the packet is not equivalent to the destination address of the first network unit.

13. The method of claim 1, wherein the send packet subroutine comprises the steps of:
a) setting the chipset for the first network unit into a transmit mode,
a) determining whether a packet data byte is available,
b) moving the available packet data byte from a transmit packet buffer to a transmitter,
c) determining whether any more data is available in the packet,
d) transmitting the data packet to the second network unit,
e) setting the chip set for the first network unit into an idle mode, and
f) decrementing a transmit retried count by a unit of one.

14. A method of transmitting and receiving a two-way serial digital signal in a wireless network having a plurality of units including at least a first and second unit, each of the plurality of units having a unique pre-defined source and destination address, the two-way serial digital signal being an original data packet, a retried data packet or an acknowledgment packet, each packet having a source and a destination address associated with the source and destination address of one of the plurality of network units, the steps of the method comprising:
a) providing an electrical circuit having a plurality of coupled components including a serial port, a media access controller, a baseband processor, an I/Q modem, an RF/IF convertor, an antennae and a DC power source for each of the plurality of network units,
b) setting the baseband processor for the first network unit into a receive mode,
c) determining whether an incoming digital signal is being received by the first network unit from one of the plurality of network units,
d) initiating a receive packet subroutine within the first network unit,
e) determining by the first network unit whether the incoming digital signal is a valid packet intended for the first network unit from a specific unit of the plurality of network units,
f) determining by the first network unit whether the valid packet is a data packet,
g) building an acknowledgment packet within the first network unit for immediate transmission to the specific unit of the plurality of network units which transmitted the digital signal to the first network unit,
h) initiating a send packet subroutine within the first network unit for transmitting a digital signal to the specific unit of the plurality of network units, the digital signal chosen from the group consisting of an acknowledgment packet, a retried data packet or an original data packet, and
i) setting the chipset for the baseband processor into an idle mode.

15. The method of claim 14, wherein subsequent to the step of setting the baseband processor into a receive mode but prior to the step of determining whether an incoming digital signal is being received by the first network unit, further comprising the steps of:
a) processing any serial port characters into a receive buffer of the first network unit, and
b) processing any characters from a transmit buffer to the serial port of the first network unit.

16. The method of claim 14, further comprising the step of terminating the transmission of a retried data packet in the event that the incoming digital signal is an acknowledgment packet having a destination address equivalent to the destination address of the first network unit.

17. The method of claim 14, wherein subsequent to setting the chipset for the first network unit into an idle mode, further comprising the step of determining whether a pre-defined time-out has elapsed.

18. The method of claim 17, wherein subsequent to determining that the pre-defined time-out has elapsed, further comprising the step of determining whether any retried or original data packets are waiting to be transmitted.

19. The method of claim 18, wherein subsequent to determining that a retried or an original data packet is waiting to be transmitted, further comprising the step of initiating the send packet subroutine.

20. The method of claim 18, wherein subsequent to determining that no retried or original data packets are waiting to be transmitted, further comprising the steps of:
a) determining whether there is enough data in a serial port receive buffer to fill a data packet,
b) building a data packet, and
c) initiating the send packet subroutine.
